(19) United States
(12) Patent Application Publication
(10) Pub. No.: US 2003/0044556 A1
(43) Pub. Date: Mar. 6, 2003

(54) Colorful sleeve and a method for making the colorful sleeve

(76) Inventors: Fu-Lai Hong, Taichung (TW); Tien-Chu Lin, Taichung (TW)

Correspondence Address: Kolisch, Hartwell, Dickinson,, McCormack & Heuser, Suite 200, 520 S.W. Yamhill Street, Portland, OR, 97204-1378, US

(21) Appl. No.: 09/946,571

(22) Filed: Sep. 4, 2001

(51) Int. Cl. B32B 1/08; B29C 39/12; B29C 39/02

(52) U.S. Cl. 428/36.9; 428/156; 264/299; 264/239; 264/245

(57) ABSTRACT

A colorful sleeve (10) is composed of a tubular body (100) and multiple patterns (101) embossed on the body (100). The colorful sleeve (10) is made of a soft and resiliently extendable plastic in one-piece, therefore, the colorful sleeve (10) adapts to directly sleeve objects such as a cup (20) for decorating and heat insulation.

### BACKGROUND OF THE INVENTION

1. Field of the Invention

The present invention relates to a colorful sleeve, and more particularly a colorful sleeve made of soft and resilient plastic in one-piece. This invention also discloses a method for making the colorful sleeve.

2. Description of Related Art

Despite many improvements in technology of plastic forming, shaping a colorful product in one process such as injection molding is still a problem. The colorful product has to be produced piece by piece in respective different colors and then the pieces are combined together to complete the colorful product.

A conventional colorful sleeve as shown in FIG. 7 is a resilient plastic sheet (60) having a baby bear pattern (61) and multiple bosses (62) formed on an outer surface thereof. The resilient plastic sheet (60) is made by pouring color plastic to desired places, such as the baby bear pattern (61) and the bosses (62), of a mold corresponding to the resilient plastic sheet (60). Then, the color plastic inside the mold is shaped, and then base plastic is poured into the mold to coagulate with the color plastic to complete the resilient plastic sheet (60).

A cup (50) is decorated with the plastic sheet (60) and the vivid appearance of the plastic sheet (60) is used to prettify the cup (50). However, because the resilient plastic sheet (60) can not adhere to the cup (50) spontaneously, a handle (51) is firmly attached to the cup (50) whereby two distal ends of the resilient plastic sheet (60) are secured on the cup (50). One advantage of the sleeve is that it can provide insulation from a hot or cold drink in the cup whereby a user's hand can remain comfortable.

However, some drawbacks exist in the conventional colorful sleeve:

1. Although the resilient plastic sheet (60) promotes the outer appearance of the cup (50), the handle (51) securing the resilient plastic sheet (60) on the cup (50) increases an extra cost of production and makes the cup (50) take more space in storage place.

2. If the handle (51) falls off from the cup (50) after a period of time because of fragility, the resilient plastic sheet (60) also separates from the cup (50).

Therefore, the present invention has arisen to mitigate and/or obviate the disadvantages of the conventional colorful sleeve.

### SUMMARY OF THE INVENTION

The main objective of the present invention is to provide a colorful sleeve that attaches to a cup directly and does not require any further securing means for attachment to the cup.

A further objective of the present invention is to provide heat insulation for the cup whereby a user does not experience hand discomfort from a temperature of a drink in the cup.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the colorful sleeve in accordance with the present invention;

FIG. 2 is a schematic flow chart of a method for making the colorful sleeve in FIG. 1;

FIG. 3 is a perspective view of an inner mold with relief recesses used in the method for making the colorful sleeve;

FIG. 4 is a perspective view of the inner mold shows that the relief recesses are filled with color plastic liquid;

FIG. 5 is a schematic view shows that an outer mold surrounds the inner mold;

FIG. 6 is a schematic view shows that the colorful sleeve is taken out from the molds; and

FIG. 7 is a perspective view of a conventional colorful sleeve with a cup.

### DETAILED DESCRIPTION OF THE INVENTION

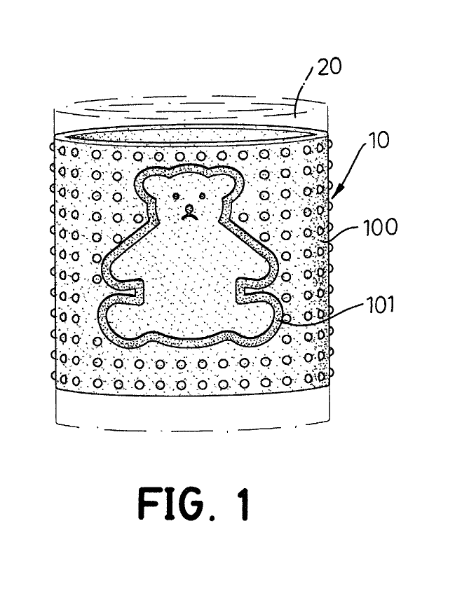

With reference to FIG. 1, a colorful sleeve (10) is made of resilient and extendable plastic and adapted to attach to an object such as a cup (20) shown in FIG. 1, wherein the colorful sleeve (10) comprises a body (100) and patterns (101) formed thereon. The body (100) is seamless and adapted to enclose the cup (20). The patterns (101) are various and embossed on the body (100). Additionally, the patterns (101) are selectively made in multiple layers to create visual attraction.

It is to be appreciated that the body can be made of materials with a high heat insulation property whereby a person holding a cup of very hot drink for example, does not experience hand discomfort.

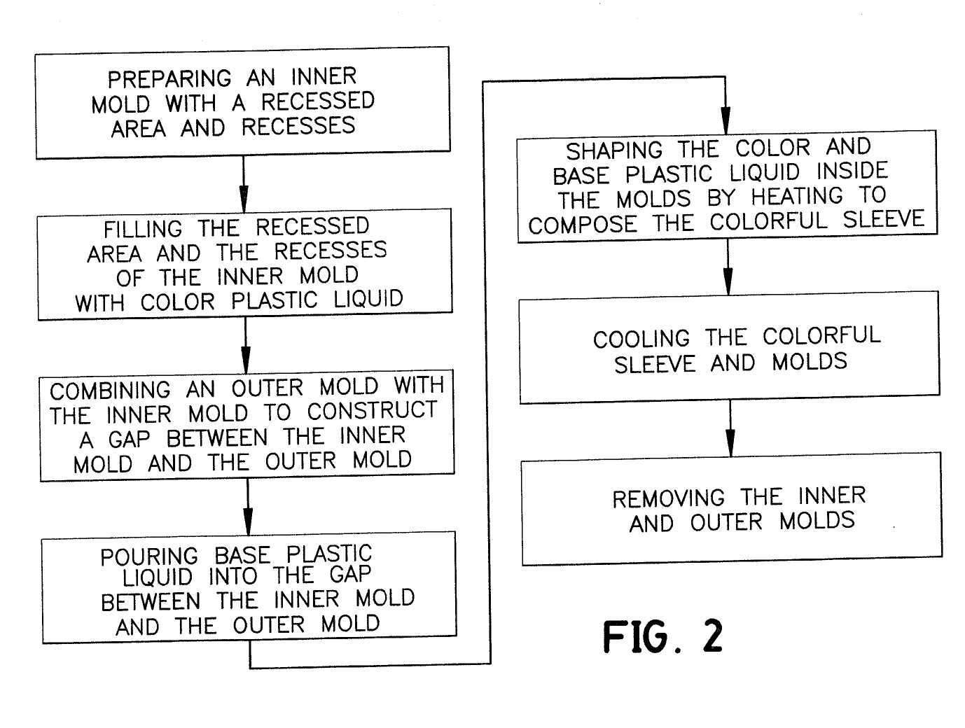

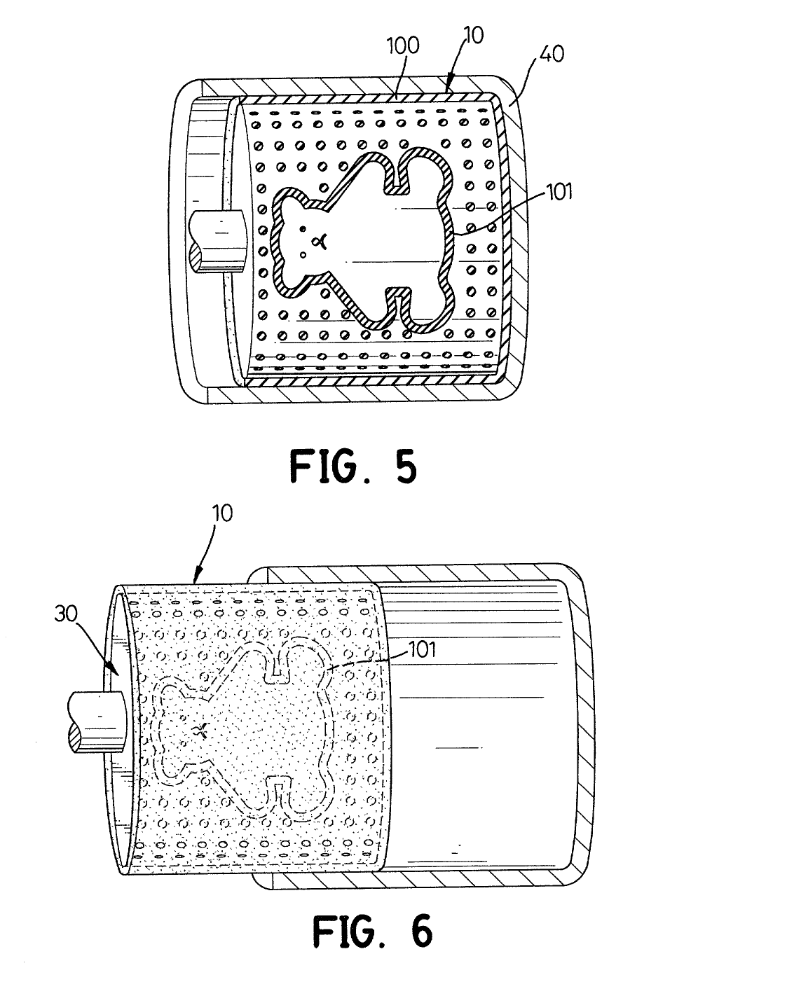

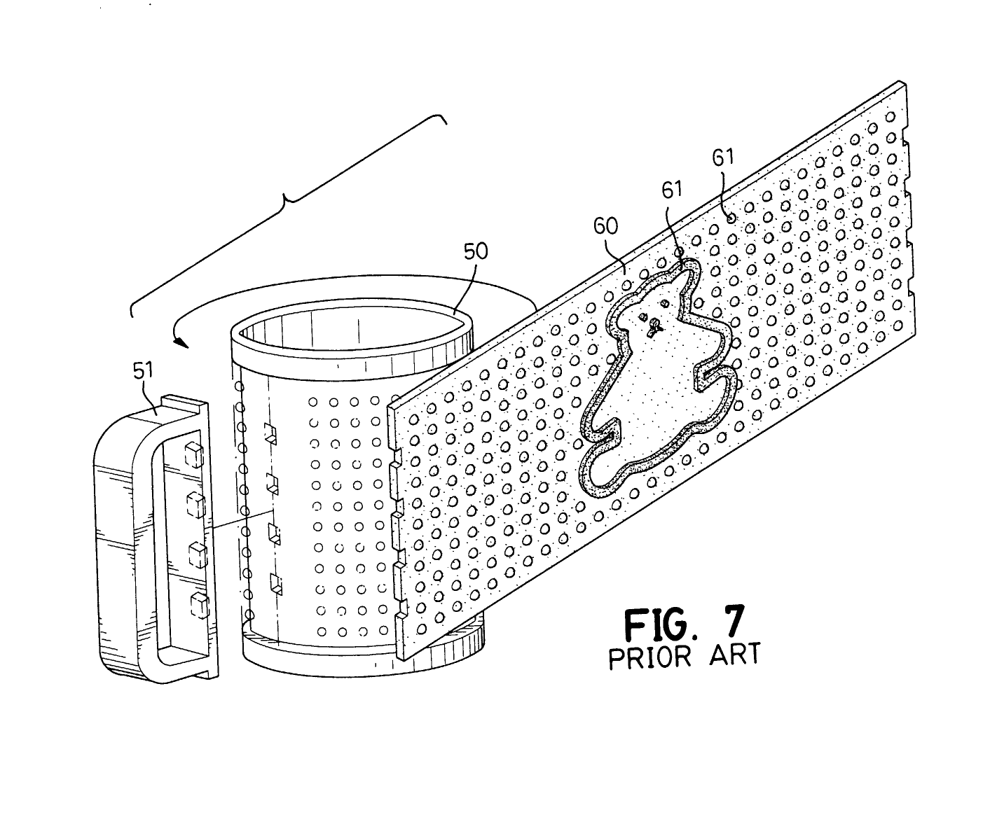

With reference to FIGS. 2-6, a method for making the colorful sleeve (10) comprises the following acts:

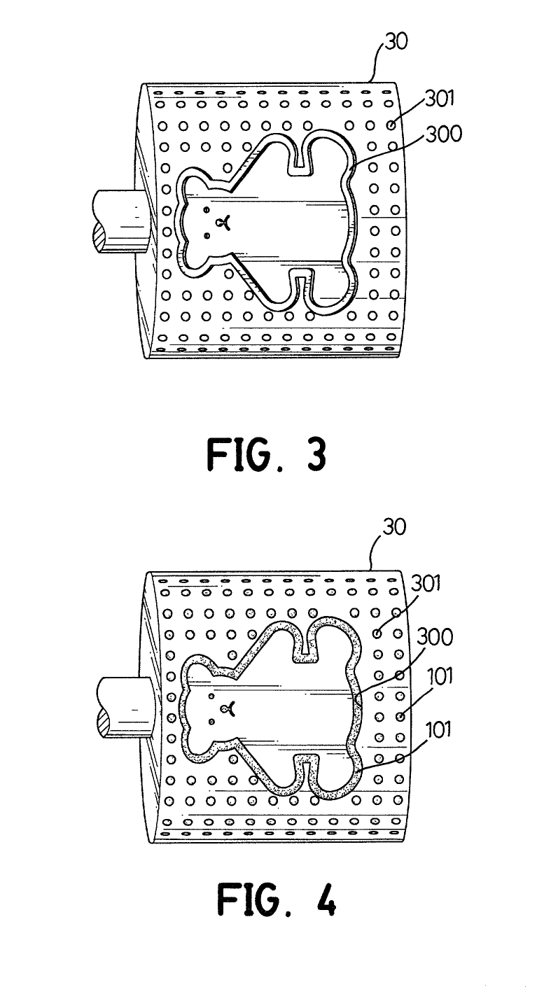

1. Preparing an inner mold (30) with a recessed area (300) and recesses (301) (shown in FIG. 3), wherein the inner mold (30) has the recessed area (300) and the recesses (301) defined in an outer periphery of the inner mold (30) so as to define a pattern and bosses of the colorful sleeve (10).

2. Filling the recessed area (300) and recesses (301) of the inner mold (30) with color plastic liquid (shown in FIG. 4), wherein the inner mold (30) is heated to 100° C. and then color plastic is melted in a liquid phase. Afterwards, the color plastic liquid is poured into the recessed area (300) and recesses (301) to compose the embossed pattern (101) of the colorful sleeve (10)

3. Combining an outer mold (40) with the inner mold (30) to construct a gap (A) between the inner mold and the outer mold (30), wherein the inner mold (30) is surrounded by an outer mold (40) that has an inner diameter larger than an outer diameter of the inner mold (30). Therefore, the gap (A) is defined between the inner mold (30) and the outer mold (40).

4. Pouring base plastic liquid into the gap (A) between the inner mold (30) and the outer mold (40), wherein base plastic liquid is poured into the gap (A) between the molds (30, 40) to compose the body (100) of the colorful sleeve (10).

5. Shaping the color and base plastic liquid by heating to compose the colorful sleeve (10), after pouring the base plastic liquid into the gap (A), the molds (30, 40) are heated to 300° C. so as to solidify the base plastic liquid and coagulate with the color plastic liquid. Therefore, the colorful sleeve (10) is in one-piece and has no seams.

6. Cooling the colorful sleeve with molds (30, 40), wherein the shaped colorful sleeve (10) with the molds (30, 40) is cooled by water.

7. Removing the molds, after cooling the colorful sleeve (10) and the molds (30, 40), the inner mold (30) with the shaped color sleeve (10) adhered on the inner mold (30) is taken out from the outer mold (40). Then the color sleeve (10) is turned inside out so as to make the embossed pattern (101) be on the outside of the colorful sleeve (10). The colorful sleeve (10) can then be fitted over the end of a cup and sleeve the cup.

Although the invention has been explained in relation to its preferred embodiment, it is to be understood that many other possible modifications and variations can be made without departing from the spirit and scope of the invention as hereinafter claimed.

What is claimed is:

1. A colorful sleeve (10) adapted to attach to a cup (20) wherein the colorful sleeve (10) comprising:
a body (100) made of resilient and extendable plastic; and
multiple and colorful patterns (101) made of resilient plastic and embossed on the body (100).

2. The colorful sleeve (10) as claimed in claim 1, wherein the multiple and colorful patterns (101) are constructed in multiple layers.

3. The colorful sleeve (10) as claimed in claim 1, wherein the resilient plastic has a high heat insulation characteristic.

4. A method for making the colorful sleeve in claim 1, wherein the method comprising:
preparing an inner mold (30) with a recessed area (300) and recesses (301);
filling the recessed area (300) and the recesses (301) of the inner mold (30) with color plastic liquid;
combining an outer mold (40) with the inner mold (30) to construct a gap (A) between the inner mold (30) and the outer mold (40);
pouring base plastic liquid into the gap (A) between the inner mold (30) and the outer mold (40) to compose the body (100) of the colorful sleeve (10);
shaping the color and base plastic liquid inside the molds (30, 40) by heating to compose the colorful sleeve (10);
cooling the colorful sleeve (10) and molds (30, 40) after the shaping act; and
removing the inner and outer molds (30, 40).
